(19) United States
(12) Patent Application Publication
(10) Pub. No.: US 2020/0339402 A1
(43) Pub. Date: Oct. 29, 2020

(54) VARIABLE SPEED CRYOGEN DOSING SYSTEM

(71) Applicant: Niagara Bottling, LLC, Diamond Bar, CA (US)

(72) Inventor: Alexander Telemachos Mouschovias, Diamond Bar, CA (US)

(73) Assignee: Niagara Bottling, LLC, Diamond Bar, CA (US)

(21) Appl. No.: 16/924,470

(22) Filed: Jul. 9, 2020

Related U.S. Application Data
(63) Continuation-in-part of application No. 15/681,123, filed on Aug. 18, 2017.
(60) Provisional application No. 62/376,598, filed on Aug. 18, 2016.

(51) Int. Cl. B67C 3/20; B67C 3/00; B67C 7/00; B67C 3/22

(52) U.S. Cl. CPC B67C 3/204; B67C 3/22; B67C 7/00; B67C 3/007

(57) ABSTRACT

An apparatus and a method are provided for a container filling and sealing production line to produce a target final pressure of liquid contents within containers during variable production line speeds. The container filling and sealing production line comprises a bottle filler that receives containers fabricated by manufacturing equipment and fills the containers with liquid contents. A cryogen dosing system adds a volume of a cryogen to the liquid contents. A bottle sealer seals the containers and entraps the cryogen and liquid contents, such that vaporization of the cryogen imparts the target final pressure of liquid contents within the containers. A communication line enables the bottle filler to pass information to the cryogen dosing system about upcoming changes in production speed such that the cryogen dosing system accordingly adjusts the volume of the cryogen.

### PRIORITY

This application is a continuation-in-part of, and claims the benefit of, U.S. patent application, entitled “Variable Speed Cryogen Dosing System,” filed on Aug. 18, 2017, and having application Ser. No. 15/681,123, which claims the benefit of, and priority to, U.S. Provisional Application, entitled “Variable Speed Cryogen Dosing System,” filed on Aug. 18, 2016 and having application Ser. No. 62/376,598, the entirety of each of said applications being incorporated herein by reference.

### FIELD

The field of the present disclosure generally relates to plastic bottles. More particularly, the field of the invention relates to a cryogen dosing system and method capable of maintaining a desired final pressure within plastic bottles during variable production line speeds.

### BACKGROUND

Many manufacturers of non-carbonated beverages, such as water, juices, teas, and the like, generally rely upon bottles formed of polyethylene terephthalate (PET). Over the years, environmental and cost pressures have led to a use of thinner-walled PET bottles, thereby reducing the weight of PET polymers in the bottles, resulting in structurally weaker bottles. After filling, however, bottles must be stacked so they can be transported to customers. As will be appreciated, weak bottles at the bottom of a pallet may buckle under the weight of the bottles above, creating unsafe conditions and costly product losses.

One technique for increasing bottle strength while minimizing the PET content of bottles is to pressurize the bottles with a compressed gas or an inert cryogen, such as nitrogen gas. As will be appreciated, nitrogen gas is particularly advantageous due to being available in liquid form and being inert, thereby protecting bottle contents from oxidation that can lead to spoilage and lost revenue. Further, a quantity of nitrogen gas occupies a volume several orders of magnitude greater than an equivalent quantity of liquid nitrogen, making nitrogen gas very well suited for pressurizing non-carbonated beverages.

Liquid nitrogen dosing systems commonly used in bottling facilities typically add a predetermined volume of liquid nitrogen, such as a droplet, to the contents of a bottle before quickly sealing the bottle. As the temperature of the liquid nitrogen increases within the bottle, the entrapped liquid nitrogen vaporizes into gaseous nitrogen increasing the pressure within the bottle. The pressure increases the rigidity of the bottle, thereby making the bottle strong enough to stack and ship.

As will be appreciated, the final pressure within the bottles is dependent upon the amount of time that elapses between dosing and sealing the bottles. As such, the speed with which the bottles are moved along a production line has a direct bearing on the final pressure. Commercially available dosing systems generally are capable of maintaining a consistent final pressure within bottles at a variety of production line speeds. As long as the production line speed is unchanging, a desired final pressure is achievable.

A drawback to conventional dosing systems, however, is that they generally cannot maintain a consistent final pressure within bottles during changing, or variable, production line speeds. For example, during an increasing line speed, the final pressure within the bottles becomes too high, producing bottles that are incapable of standing upright. During a decreasing line speed, the final pressure becomes too low, producing bottles that are too weak to be stacked, as described above. What is needed, therefore, is a cryogen dosing system capable of maintaining a desired final pressure within PET bottles during changing production line speeds.

### SUMMARY

An apparatus and a method are provided for a container filling and sealing production line to produce a target final pressure of liquid contents within polyethylene terephthalate (PET) bottles during variable production line speeds. The container filling and sealing production line comprises a bottle filler that is configured to receive PET bottles fabricated by bottle manufacturing equipment and fill the PET bottles with liquid contents. A cryogen dosing system is configured to add a volume of a cryogen to the liquid contents. A bottle sealer is configured to cap the PET bottles and entrap the cryogen and liquid contents, such that vaporization of the cryogen imparts the target final pressure of liquid contents within the PET bottles. A first communication line enables the bottle filler to pass information to the cryogen dosing system about upcoming changes in production speed such that the cryogen dosing system accordingly adjusts the volume of the cryogen.

In an exemplary embodiment, a container filling and sealing production line to produce a target final pressure of liquid contents within containers during variable production line speeds comprises: a container filler configured to receive containers fabricated by manufacturing equipment and fill the containers with liquid contents; a cryogen dosing system configured to add a volume of a liquid gas to the liquid contents; a container sealer configured to seal the containers and entrap the liquid gas and liquid contents, such that vaporization of the liquid gas imparts the target final pressure of liquid contents within the containers; and a first communication line whereby the container filler passes information to the cryogen dosing system about upcoming changes in production speed, the cryogen dosing system adjusts the volume of the liquid gas according to the information.

In another exemplary embodiment, the liquid gas is comprised of a cryogen. In another exemplary embodiment, a second communication line whereby the cryogen dosing system passes feedback information to the container filler. In another exemplary embodiment, the liquid contents comprises a non-carbonated beverage, such as water, juice, tea, and the like. In another exemplary embodiment, the liquid gas comprises liquid nitrogen.

In another exemplary embodiment, the information includes any of a rate of the change in speed, a duration of the change in speed, a cryogen dose timing, a duration of an individual cryogen dosing, a duration between dosing and sealing of each container, and the like. In another exemplary embodiment, the cryogen dosing system uses the information to compute a duration of cryogen dosing required to produce the target final pressure within the containers. In another exemplary embodiment, the container filler computes a duration of cryogen dosing required to produce the target final pressure within the containers and then passes the resulting information to the cryogen dosing system by way of the first communication line. In another exemplary embodiment, the duration of cryogen dosing is computed as a linear function of the duration between dosing and sealing of the containers.

In another exemplary embodiment, the feedback information includes any of a cryogen dose timing, a cryogen dose duration, and the like. In another exemplary embodiment, the container filler and the cryogen dosing system each perform a portion of the calculations required to produce the target final pressure and then intercommunicate the resulting information with one another by way of the first and second communication lines. In another exemplary embodiment, at least the container filler comprises a programmable logic controller (PLC) configured to process instructions stored on a non-transient machine-readable medium, such as a memory. In another exemplary embodiment, the PLC incorporated into the container filler processes the stored instructions to cause the container filling and sealing production line to perform operations so as to produce the target final pressure within the containers.

In another exemplary embodiment, any of the container filler, the cryogen dosing system, or the container sealer comprises a PLC and intercommunicate by way of at least the first and second communication lines so as to produce the target final pressure within the containers. In another exemplary embodiment, any of the container filler, the cryogen dosing system, or the container sealer that comprise a PLC, may be network connected to a local area network (LAN). In another exemplary embodiment, the first and second communication lines comprise physical, wired connections that convey an established communication protocol, such as RS-232, Ethernet TCP/IP, and the like. In another exemplary embodiment, the first and second communication lines comprise wireless connections, such as Wi-Fi, Bluetooth, or other similar wireless connections. In another exemplary embodiment, the PLC incorporated into any of the container filler, the cryogen dosing system, or the container sealer may be configured to allow for human interaction, such that the container filling and sealing production line may be switched into a manual operational mode.

In an exemplary embodiment, a method for producing a target final pressure of liquid contents within containers during variable production line speeds comprises: configuring a bottle filler to fill the containers with the liquid contents and yield information about the production line speed; calibrating a programmable logic controller (PLC) to determine a duration of cryogen dosing based on production line speed, the PLC being coupled with the bottle filler; computing a forthcoming duration of cryogen dosing required to produce the target final pressure based on an upcoming production line speed; passing the forthcoming duration of cryogen dosing to a cryogen dosing system; and sealing the containers so as to entrap the cryogen and the liquid contents, such that vaporization of the cryogen imparts the target final pressure of liquid contents within the containers.

In another exemplary embodiment, calibrating comprises developing a linear relationship between the duration of cryogen dosing and a duration elapsing between cryogen dosing and sealing of the PET bottles. In another exemplary embodiment, developing comprises at least operating the production line at a first constant speed and a second constant speed, the second constant speed being greater than the first constant speed, adjusting the duration of cryogen dosing during each of the first and second constant speeds such that the target final pressure within the containers is produced, and using the durations of the cryogen dosing to apply the linear relationship for substantially all production line speeds. In another exemplary embodiment, computing comprises identifying the upcoming production line speed, determining a corresponding duration between cryogen dosing and sealing of the containers, and calculating a corresponding duration of cryogen dosing that imparts the target final pressure of liquid contents to the containers.

In an exemplary embodiment, a container filling and sealing production line to produce a target final pressure of liquid contents within containers comprises: a container filler for receiving containers and adding liquid contents into the containers; a cryogen dosing system for adding a volume of a liquid gas to the liquid contents; a container sealer for sealing the containers to entrap the liquid gas and liquid contents, such that vaporization of the liquid gas imparts the target final pressure of liquid contents within the containers; and a first communication line for passing information from the container filler to the cryogen dosing system about upcoming changes in production speed.

In another exemplary embodiment, the production line further comprises a second communication line whereby the cryogen dosing system passes feedback information to the container filler. In another exemplary embodiment, the information includes any of a rate of the change in speed, a duration of a stoppage of the production line, a duration of a change in speed, a cryogen dose timing, a duration of an individual cryogen dosing, a duration between dosing and sealing of each container. In another exemplary embodiment, the cryogen dosing system uses the information to compute a duration of cryogen dosing required to produce the target final pressure within the containers. In another exemplary embodiment, the container filler computes a duration of cryogen dosing required to produce the target final pressure within the containers and then passes the resulting information to the cryogen dosing system by way of the first communication line. In another exemplary embodiment, the duration of cryogen dosing is computed as a linear function of the duration between dosing and sealing of the containers.

In another exemplary embodiment, at least the container filler comprises a programmable logic controller (PLC) configured to process instructions stored on a non-transient machine-readable medium, such as a memory. In another exemplary embodiment, the PLC processes the stored instructions to cause the container filling and sealing production line to perform operations so as to produce the target final pressure within the containers. In another exemplary embodiment, any of the container filler, the cryogen dosing system, or the container sealer comprises a PLC and intercommunicate by way of at least the first communication line and a second communication line to produce the target final pressure within the containers. In another exemplary embodiment, any of the container filler, the cryogen dosing system, or the container sealer that comprise a PLC, may be network connected to a local area network (LAN). In another exemplary embodiment, the first communication line and the second communication line comprise wired connections that convey an established communication protocol. In another exemplary embodiment, the first communication line and the second communication line comprise wireless connections. In another exemplary embodiment, the PLC incorporated into any of the container filler, the cryogen dosing system, or the container sealer is configured to allow for human interaction.

In an exemplary embodiment, a method for producing a target final pressure of liquid contents within containers in a production line comprises: adding liquid contents to the containers; determining a production line speed; computing a duration of cryogen dosing required to produce the target final pressure based on the production line speed; adding a cryogen to the liquid contents within the containers according to the duration of cryogen dosing; and sealing the containers to entrap the cryogen and the liquid contents such that vaporization of the cryogen imparts the target final pressure within the containers.

In another exemplary embodiment, computing comprises identifying an upcoming production line speed, determining a corresponding duration between cryogen dosing and sealing of the containers, and calculating a corresponding duration of cryogen dosing that imparts the target final pressure within the containers. In another exemplary embodiment, determining a production line speed includes determining when the production line is stopped. In another exemplary embodiment, computing the duration of cryogen dosing includes accounting for a duration when the production line is stopped. In another exemplary embodiment, computing the duration of cryogen dosing includes recording an elapsed time between stopping and starting the production line. In another exemplary embodiment, computing the duration of cryogen dosing includes increasing the duration of cryogen dosing according to the elapsed time to achieve the final target pressure within the containers.

### BRIEF DESCRIPTION OF THE DRAWINGS

The drawings refer to embodiments of the present disclosure in which:

FIG. 1 illustrates a schematic of an exemplary embodiment of a container filling and sealing production line that comprises a cryogen dosing system, according to the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first bottle,” may be made. However, the specific numeric reference should not be interpreted as a literal sequential order but rather interpreted that the “first bottle” is different than a “second bottle.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present disclosure describes an apparatus and a method for a container filling and sealing production line to produce a target final pressure of liquid contents within containers during variable production line speeds. In some embodiments, the containers being pressurized may be polyethylene terephthalate (PET) bottles. As should be readily apparent to those skilled in the art, however, the apparatus and methods disclosed herein are not limited to pressurizing PET bottles. Rather, although PET bottles are specifically discussed in the following paragraphs, it should be understood that the apparatus and method disclosed herein may be incorporated into the production of a wide variety of packaged consumable products that may have a need for pressurized containers, such as, by way of non-limiting example, various foods, medicines, as well as beverage products.

In some embodiments, the container filling and sealing production line comprises a bottle filler configured to receive PET bottles fabricated by bottle manufacturing equipment and fill the PET bottles with non-carbonated liquid contents, such as water, juice, tea, and the like. A cryogen dosing system is configured to add a volume of a cryogen, such as liquid nitrogen, to the liquid contents. A bottle sealer is configured to cap the PET bottles and entrap the cryogen and liquid contents, such that vaporization of the cryogen imparts the target final pressure of liquid contents within the PET bottles. A first communication line enables the bottle filler to pass information to the cryogen dosing system about upcoming changes in production speed, such that the cryogen dosing system adjusts the volume of the cryogen accordingly. In one embodiment, the information may include any of a rate of a change in speed, a duration of the change in speed, a cryogen dose timing, a duration of an individual cryogen dosing, a duration between dosing and sealing of each bottle, and the like. In one embodiment, the bottle filler may compute a duration of cryogen dosing required to produce the target final pressure within the bottles and then pass the resulting information to the cryogen dosing system by way of the first communication line. An optional second communication line enables the cryogen dosing system to pass feedback information to the bottle filler, such as a cryogen dose timing or a cryogen dose duration.

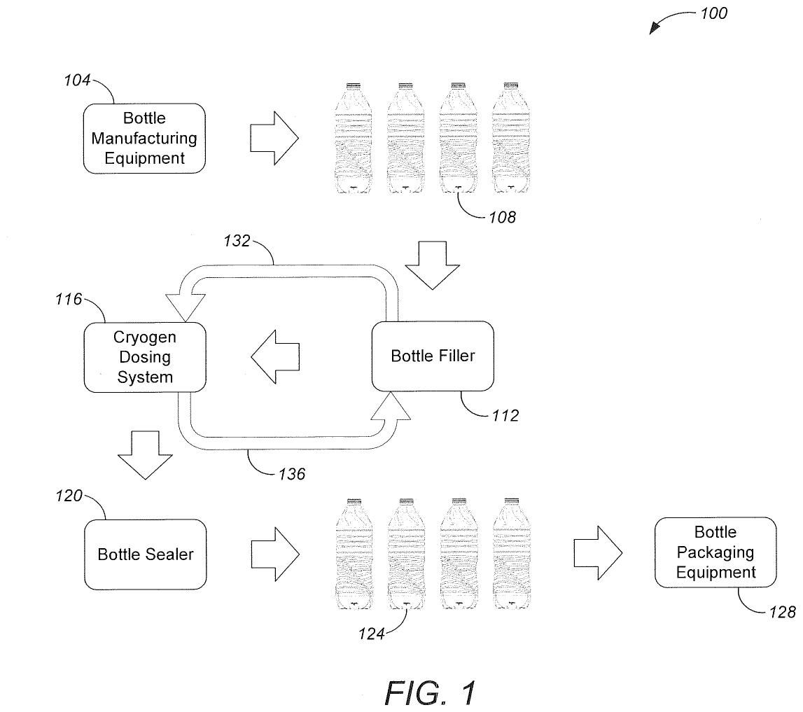

FIG. 1 illustrates an exemplary embodiment of a container filling and sealing production line 100 comprising a cryogen dosing system. As shown, the production line 100 begins with bottle manufacturing equipment 104 whereby a multiplicity of empty polyethylene terephthalate (PET) bottles 108 are fabricated. The bottle manufacturing equipment 104 generally comprises all those certain machines typically used to produce PET bottles 108 that are ready to be filled with liquid contents. The empty PET bottles 108 then are passed to a bottle filler 112 configured to fill the bottles with a predetermined volume of liquid contents. Preferably, the liquid contents comprises a non-carbonated beverage, such as water, juice, tea, and the like.

As discussed herein, an absence of carbonation necessitates pressurizing the PET bottles 108, such that bottles at the bottom of a stacked pallet do not buckle under the weight of the bottles above. Thus, pressurizing the PET bottles 108 imparts a degree of rigidity suitable for stacking the bottles. After receiving contents at the bottle filler 112, the PET bottles are passed to a cryogen dosing system 116. In some embodiments, however, the cryogen dosing system 116, as well as a bottle sealer, may be located inside the bottle filler 112. In the embodiment illustrated in FIG. 1, the cryogen dosing system 116 adds a predetermined volume of a liquid gas, such as a droplet of liquid nitrogen, to the contents of each of the PET bottles 108 before the bottles are passed to a bottle sealer 120. As will be appreciated, the temperature of the liquid nitrogen immediately increases upon entering the bottle, and thus the liquid nitrogen begins vaporizes into gaseous nitrogen. Once the bottle sealer 120 caps the bottle, the vaporizing nitrogen is entrapped, thereby increasing the pressure within the bottle. The pressure increases the rigidity of the bottle, thereby making the bottle strong enough to stack onto pallets. As shown in FIG. 1, the production line 100 passes a multiplicity of pressurized bottles 124 from the bottle sealer 120 to bottle packaging equipment 128. In some embodiments, the internal pressure within the pressurized bottles 124 may be within a range of substantially 2.5 PSI and 4.5 PSI. In one embodiment, the pressurized bottles 124 have an internal pressure of substantially 4.0 PSI. It is contemplated, however, that lower internal pressures may be also be advantageously achieved. As will be recognized, the bottle packaging equipment 128 comprises all those certain machines generally used to package the pressurized bottles 124 and stack the bottles onto pallets in preparation for shipping.

As will be appreciated, the final pressure within the bottles 124 depends upon the amount of time that elapses during passing the bottle from the cryogen dosing system 116 and the bottle sealer 120. Thus, the speed with which the PET bottles 108 are moved along the production line 100 has a direct bearing on the final pressure within the bottles 124. The cryogen dosing system 116 is capable of producing a substantially consistent pressure within the bottles 124 so long as the production line 100 moves at a constant speed. In one embodiment, the cryogen dosing system 116 is capable of producing a target final pressure between 2.5 PSI and 4.5 PSI within the bottles 124 with an accuracy of substantially 1 PSI, during any constant production line speed between 242 bottles per minute (BPM) and 1200 BPM.

As will be appreciated, during variable production line speeds, such as when the production line 100 is increasing or decreasing in speed, the amount of time between dosing and sealing each bottle is changing. Further, in some instances, the rate of change in production line speed may be variable, as well. Thus, the amount of cryogen dosing applied to the bottles 108 must be adjusted in proportion to the change in production line speed so as to produce the target final pressure in the bottles 124 during all production line speeds. In some embodiments, the amount of cryogen dosing applied to the bottles 108 may be adjusted in inverse proportion to the time between dosing and bottle sealing. To this end, a communication line 132 extends from the bottle filler 112 to the cryogen dosing system 116, as illustrated in FIG. 1. The communication line 132 enables information related to the speed of the production line 100 to be passed from the bottle filler 112 to the cryogen dosing system 116. In one embodiment, the bottle filler 112 may pass information to the cryogen dosing system 116 about an upcoming change in speed before the change in speed occurs. The information may include, but is not necessarily limited to, a rate of the change in speed, a duration of the change in speed, a cryogen dose timing, a duration t_{d} of an individual cryogen dosing, a duration tᵤ between dosing and sealing of each bottle 108, and the like. The cryogen dosing system 116 may then utilize the received information to compute an amount or duration of cryogen dosing required to produce the target final pressure within the bottles 124.

In some embodiments, the bottle filler 112 may compute the amount or duration of cryogen dosing required to produce the target final pressure within the bottles 124 and then pass the resulting information to the cryogen dosing system 116 by way of the communication line 132. In some embodiments, the cryogen dosing system 116 may pass feedback information related to cryogen dose timing or cryogen dose duration to the bottle filler 112 by way of a communication line 136. In some embodiments, the bottle filler 112 and the cryogen dosing system 116 may each perform a portion of the calculations required to produce the target final pressure within the bottles 124, and then intercommunicate results with one another by way of the communication lines 123, 136.

It should be understood that at least the bottle filler 112 may be comprised of a programmable logic controller (PLC), an automated PLC system, and/or a standard computer that is configured to process instructions stored on a non-transient machine-readable medium, such as a memory. As such, the PLC incorporated into the bottle filler 112 processes the stored instructions which causes the production line 100 to perform operations, discussed herein, so as to produce the target final pressure within the bottles 124. In some embodiments, however, any of the bottle filler 112, the cryogen dosing system 116, or the bottle sealer 120 may comprise a PLC, and intercommunicate by way of at least the communication lines 132, 136 so as to produce the target final pressure within the bottles 124. Further, in some embodiments, the PLC incorporated into any of the bottle filler 112, the cryogen dosing system 116, or the bottle sealer 120 may be configured to allow for human interaction, such that the production line 100 may be switched into a manual operational mode.

In some embodiments, any of the bottle filler 112, the cryogen dosing system 116, or the bottle sealer 120 that comprise a PLC, may be network connected to a local area network (LAN). Thus, the communication lines 132, 136 may comprise physical, wired connections that convey an established communication protocol, such as, by way of non-limiting example, RS-232, Ethernet TCP/IP, and the like. In some embodiments, the communications lines 132, 136 may comprise wireless connections, such as Wi-Fi, Bluetooth, or other similar wireless connections.

It should be understood that for a particular cryogen dosing rate, the final target pressure of the bottles 124 is proportional to the duration t_{d} during which each bottle 108 is dosed with cryogen and inversely proportional to the duration tᵤ between dosing and sealing of the bottles 108. When the production line 100 moves at a low speed, the duration of each dose t_{d} must be increased to compensate for a relatively large duration tᵤ between dosing and sealing of the bottles 108. When operating faster production line speeds, however, the bottles 108 move more quickly between the cryogen dosing system 116 and the bottle sealer 120, and thus the duration of each dose t_{d} must be reduced to compensate for relatively smaller values of tᵤ. As will be appreciated, therefore, when the speed of the production line 100 is changing, the dose duration t_{d} must be varied according to the changing duration tᵤ during which the bottles 108 are unsealed. In the embodiment illustrated in FIG. 1, the value of tᵤ generally depends upon the acceleration profile of the bottle filler 112. It is envisioned that the value of tᵤ may be supplied by a manufacturer of the bottle filler 112, calculated by way of theoretical values, or measured experimentally by way of any of various techniques, such as, by way of non-limiting example, coupling a rotary encoder or a high-speed camera with the bottle filler.

As will be appreciated, that may be instances when the production line 100 may be stopped and then restarted due to any of various manufacturing-related factors that may arise along the production line 100. When the production line 100 comes to a halt, the duration tᵤ between dosing and sealing of the bottles 108 becomes relatively extended. As such, the duration t_{d} during which each bottle 108 is dosed with cryogen must be correspondingly increased to account for the extra time between dosing and sealing the bottles 108. In some embodiments, the value of tᵤ may depend on the acceleration profile of the bottle filler 112 in the moments just prior to stopping the production line 100. Further, in some embodiments, the value of tᵤ during a stoppage of the production line 100 may comprise one or more values supplied by a manufacturer of the bottle filler 112. In some embodiments, tᵤ may be calculated by way of theoretical values or measured experimentally by way of any of various techniques, as described herein. Furthermore, in some embodiments, t^{u} may comprise a recording of the elapsed time between stopping and starting the production line 100, and t_{d} may be correspondingly increased to achieve the final target pressure of the bottles 124.

As will be recognized by those skilled in the art, the volume of cryogen injected into each of the bottles 108 is relatively small compared to the volume of liquid contents within the bottles, and thus the applied cryogen has little effect on an average temperature of the liquid contents. The vaporization rate of the cryogen will, therefore, be a linear function of time that may be expressed in terms of t_{d} and tᵤ in the form:

t_{d}=mtᵤ+b

where m and b are constants that depend upon a specific application, and may be determined based on two calibration points by way of expressions of the form:

$$m = \frac{{t}_{d , i} - {t}_{d , j}}{{t}_{u , i} - {t}_{u , j}}$$

$$b = {t}_{d , k} - ( \frac{{t}_{d , i} - {t}_{d , j}}{{t}_{u , i} - {t}_{u , j}} ) {t}_{u , k}$$

where i and j represent constant values of t_{d} and tᵤ during two distinct operational speeds of the bottle filler 112, and k may represent constant values of t_{d} and tᵤ during any chosen speed of the bottle filler. Preferably, however, i and j are chosen to respectively represent a slowest and fastest speed of the bottle filler 112, and k may be set equal to either i or j.

It should be understood, therefore, that for any embodiment of the production line 100, once m and b are determined, then the dose duration t_{d} may be determined in real-time as a function of the duration tᵤ. In one experimental embodiment, the production line 100 was operated at a first constant speed of 100 BPM and then at a second constant speed of 1300 BPM. Direct observation of the time taken for the bottles 108 to pass from the cryogen dosing system 116 to the bottle sealer 120 at each speed yielded respective unsealed durations, t_{u,100}=9.6 s and t_{u,1300}=0.73846 s. Using these values of the unsealed duration as two calibration points and directly observing the final pressure in the bottles 124 led to corresponding values for the dosing duration, given by t_{d,100}=12.5 ms and t_{d,1300}=10.0 ms, respectively. With two calibration known values for each of the unsealed duration and the dosing duration in hand, values for m and b were determined thusly:

$$m = \frac{0.0125 - 0.010 \; 0}{96 - 0.738 \; 46} = 2.82118 \times 1 {0}^{- 4} \\ b = ( 0.0125 s ) - ( \frac{0.0.125 - 0.010 \; 0}{9.6 - 0.738 \; 46} ) ( 9.6 s ) = 9.79167 \times 1 {0}^{- 3} s$$

Substituting the calibrated values for m and b into the linear relationship between t_{d} and tᵤ then yielded the expression:

t_{d}=(2.82118×10⁻⁴)tᵤ+(9.79167×10⁻³s)

As described above, this expression enables a real-time computation of the dose duration t_{d} as a function of the duration tᵤ during which the bottles 108 pass from the cryogen dosing system 116 to the bottle sealer 120. Therefore, when the speed of the production line 100 is changing, the dose duration t_{d} may be varied according to the changing duration tᵤ based on the acceleration profile of the bottle filler 112. It should be further understood that the above values for m and b, as well as the expression for t_{d}, are specific to the particular application used during experimentation. Various other embodiments of the production line 100 will give rise to different values for m and b, and thus yield different relationships between t_{d} and tᵤ, without limitation, and without deviation beyond the spirit and scope of the present disclosure.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A container filling and sealing production line to produce a target final pressure of liquid contents within containers, comprising:
a container filler for receiving containers and adding liquid contents into the containers;
a cryogen dosing system for adding a volume of a liquid gas to the liquid contents;
a container sealer for sealing the containers to entrap the liquid gas and liquid contents, such that vaporization of the liquid gas imparts the target final pressure of liquid contents within the containers; and
a first communication line for passing information from the container filler to the cryogen dosing system about upcoming changes in production speed.

2. The production line of claim 1, further comprising a second communication line whereby the cryogen dosing system passes feedback information to the container filler.

3. The production line of claim 1, wherein the information includes any of a rate of the change in speed, a duration of a stoppage of the production line, a duration of a change in speed, a cryogen dose timing, a duration of an individual cryogen dosing, a duration between dosing and sealing of each container.

4. The production line of claim 3, wherein the cryogen dosing system uses the information to compute a duration of cryogen dosing required to produce the target final pressure within the containers.

5. The production line of claim 3, wherein the container filler computes a duration of cryogen dosing required to produce the target final pressure within the containers and then passes the resulting information to the cryogen dosing system by way of the first communication line.

6. The production line of claim 5, wherein the duration of cryogen dosing is computed as a linear function of the duration between dosing and sealing of the containers.

7. The production line of claim 1, wherein at least the container filler comprises a programmable logic controller (PLC) configured to process instructions stored on a non-transient machine-readable medium, such as a memory.

8. The production line of claim 7, wherein the PLC processes the stored instructions to cause the container filling and sealing production line to perform operations so as to produce the target final pressure within the containers.

9. The production line of claim 1, wherein any of the container filler, the cryogen dosing system, or the container sealer comprises a PLC and intercommunicate by way of at least the first communication line and a second communication line to produce the target final pressure within the containers.

10. The production line of claim 9, wherein any of the container filler, the cryogen dosing system, or the container sealer that comprise a PLC, may be network connected to a local area network (LAN).

11. The production line of claim 10, wherein the first communication line and the second communication line comprise wired connections that convey an established communication protocol.

12. The production line of claim 10, wherein the first communication line and the second communication line comprise wireless connections.

13. The production line of claim 9, wherein the PLC incorporated into any of the container filler, the cryogen dosing system, or the container sealer is configured to allow for human interaction.

14. A method for producing a target final pressure of liquid contents within containers in a production line, comprising:
adding liquid contents to the containers;
determining a production line speed;
computing a duration of cryogen dosing required to produce the target final pressure based on the production line speed;
adding a cryogen to the liquid contents within the containers according to the duration of cryogen dosing; and
sealing the containers to entrap the cryogen and the liquid contents such that vaporization of the cryogen imparts the target final pressure within the containers.

15. The method of claim 14, wherein computing comprises identifying an upcoming production line speed, determining a corresponding duration between cryogen dosing and sealing of the containers, and calculating a corresponding duration of cryogen dosing that imparts the target final pressure within the containers.

16. The method of claim 14, wherein determining a production line speed includes determining when the production line is stopped.

17. The method of claim 14, wherein computing the duration of cryogen dosing includes accounting for a duration when the production line is stopped.

18. The method of claim 17, wherein computing the duration of cryogen dosing includes recording an elapsed time between stopping and starting the production line.

19. The method of claim 18, wherein computing the duration of cryogen dosing includes increasing the duration of cryogen dosing according to the elapsed time to achieve the final target pressure within the containers.
